(19) United States
(12) Patent Application Publication
(10) Pub. No.: US 2015/0190009 A1
(43) Pub. Date: Jul. 9, 2015

(54) Insulated Baking Pan

(71) Applicant: Felicia C. Went, St. Michael (BB)

(72) Inventor: Felicia C. Went, St. Michael (BB)

(21) Appl. No.: 14/558,919

(22) Filed: Dec. 3, 2014

Related U.S. Application Data
(63) Continuation of application No. 61/924,344, filed on Jan. 7, 2014.

(51) Int. Cl. A47J 27/10

(52) U.S. Cl. CPC A47J 27/10

(57) ABSTRACT

An insulated baking pan that includes an inner pan and an outer pan, forming a double walled construction. The upper end of the inner pan includes a flange adapted to rest on the upper end of the outer pan such that the inner pan is suspended within the interior volume of the outer pan without directly contacting the interior thereof. In this way, the inner pan and the outer pan are separated by a space that can be filled with water. The water evenly applies heat to the inner pan as the baking pan is heated. The flange includes a plurality of apertures for allowing steam from the water to escape from the space between the inner and outer pans. In some embodiments, the flange also includes an opening thereon so as to allow a user to add water to the outer pan without removing the inner pan.

### CROSS REFERENCE TO RELATED APPLICATION

This application claims the benefit of U.S. Provisional Application No. 61/924,344 filed on Jan. 7, 2014. The above identified patent application is herein incorporated by reference in its entirety to provide continuity of disclosure.

### BACKGROUND OF THE INVENTION

1. Field of the Invention

The present invention relates to a baking pan. More specifically, the present invention pertains to an improved baking pan having an inner pan and an outer pan, forming a double walled construction, wherein the outer pan is adapted to hold water therein. When the baking pan is heated, the water therein serves to evenly heat the inner pan.

It is important to use proper bake ware and baking tools to ensure successful baking. Different cooking times and oven temperatures are required depending upon the size of the bake ware selected by the baker. Traditional baking pans and bake ware comprise a single walled construction. In use, the air near the heat source rises in temperature and provides heat to the pan and the batter within the pan. However, the heated air does not uniformly circulate throughout the interior of the oven, and therefore cause the batter to cook unevenly.

Thus, some individuals rotate the bake ware during the baking process to ensure that heated air is exposed to different parts of the bake ware. Rotating the bake ware throughout the baking process, however, can be inconvenient. Additionally, an individual can risk burning his or her hands when handling hot bake ware. Other individuals utilize a convection oven that can circulate air around food, allowing the food to cook more evenly. Utilizing a convection oven, however, can be impractical, as many users may not own a convection oven. Furthermore, convection ovens cannot provide direct heat to the bake ware.

The present invention provides an insulated bake pan that comprises an inner pan and an outer pan used in combination in order to form a double walled construction. The inner pan is composed of an insulating and preferably non-stick material that is molded to form an interior volume adapted to hold batter therein. The outer pan is configured to hold the inner pan therein, and is composed of a material that can withstand high heat, such as metal or a ceramic material.

In one embodiment, each of the inner pan and the outer pan comprises a rectangular shape having a bottom wall and side walls extending upward therefrom, leaving the top open. The inner pan comprises a flange around the upper end thereof. The flange rests on the upper end of the outer pan so that the bottom wall and the side walls of the inner pan extends into the interior volume of the outer pan. The inner pan and the outer pan are dimensioned such that the sidewalls and bottom wall of the inner pan does not contact the outer pan and the two pans are separated by a space, which can be filled with water. The water can help evenly distribute the heat to the inner pan by directly contacting all portions thereof. In this way, the present invention facilitates baking food evenly.

2. Description of the Prior Art

Devices have been disclosed in the prior art that claim double pan utensils. These include devices that have been patented and published in patent application publications. Some of these devices disclose baking pans that are nested inside of each other. Other devices disclose insulated baking pans with a reservoir for holding a smaller pan therein. These devices, however, do not disclose an inner pan and an outer pan, wherein the inner pan is adapted to be suspended within the interior volume of the outer pan. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 3,946,893, U.S. Pat. No. 1,296,423, U.S. Pat. No. 7,478,588, and U.S. Pat. No. 1,152,308 disclose baking apparatuses that comprise at least one outer pan and at least one inner pan. The inner pans are nested inside the outer pans such that the bottom wall of the inner pans rests directly atop the bottom wall of the outer pans, and the side walls of the inner pans and the side walls of the outer pans are separated by a space. In some embodiments, the outer pans can be filled with water so that the side walls of the inner pans can be surrounded by water.

The foregoing devices, however, do not disclose an inner pan comprising a flange on an upper end thereof similar to the present invention. In this way, the bottom wall of the inner pan is elevated above the bottom wall of the outer pan, creating a space that can be filled with water. Thus, the present invention allows water to directly contact the bottom wall as well as the side walls of the inner pan.

Finally, U.S. Patent Application Publication Number 2010/0260909 discloses a baking apparatus having a built-in reservoir for holding a smaller pan therein. The pan is partially submerged within the reservoir and is held in place via a lip that extends from the upper end of the pan. The lip, however, does not comprise a plurality of apertures thereon. Further, the lip does not comprise an opening that can be used to add more water into the baking apparatus.

The devices disclosed in the prior art have several known drawbacks. These devices are limited in that the bottom wall of the inner pan is not elevated above the bottom wall of the outer pan. Furthermore, the prior art devices do not disclose a flange or a lip having a plurality of apertures thereon so as to allow steam or vapor from the water in the outer pan to escape. The present invention overcomes these limitations by disclosing an insulated baking pan having an inner pan that is positioned within an outer pan. The inner pan comprises a flange around the upper end thereof. The flange comprises a plurality of apertures for allowing steam or vapor to escape therethrough. Additionally, the flange comprises an opening so as to allow a user to add more water into the outer pan.

It is therefore submitted that the present invention is substantially divergent in design elements from the prior art, and consequently it is clear that there is a need in the art for an improvement to double pan utensils. In this regard, the instant invention substantially fulfills these needs.

### SUMMARY OF THE INVENTION

In view of the foregoing disadvantages inherent in the known types of double pan utensils now present in the prior art, the present invention provides a new and improved insulated baking pan wherein the same can be utilized for baking food items.

It is therefore an object of the invention to provide a new and improved insulated baking pan that has all of the advantages of the prior art and none of the disadvantages.

Another object of the present invention is to provide a new and improved insulated baking pan that is adapted to bake foods evenly.

Yet another object of the present invention is to provide a new and improved insulated baking pan that allows a user to easily adjust the water level therein.

Still yet another object of the present invention is to provide a new and improved insulated baking pan that comprises various shapes and sizes, depending upon embodiment.

Still yet another object of the present invention is to provide a new and improved insulated baking pan wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a disassembled view of the present invention.

FIG. 2 shows a perspective view of the present invention.

FIG. 3 shows a cross sectional view of the present invention.

FIG. 4 shows another embodiment of the present invention.

FIG. 5 shows yet another embodiment of the present invention.

### DETAILED DESCRIPTION OF THE INVENTION

References are made herein to the attached drawings. Like reference numerals are used throughout the drawings to depict like or similar elements of the insulated baking pan. For the purposes of presenting a brief and clear description of the present invention, the preferred embodiment will be discussed as used to bake food items. The figures are intended for representative purposes only and should not be considered to be limiting in any respect.

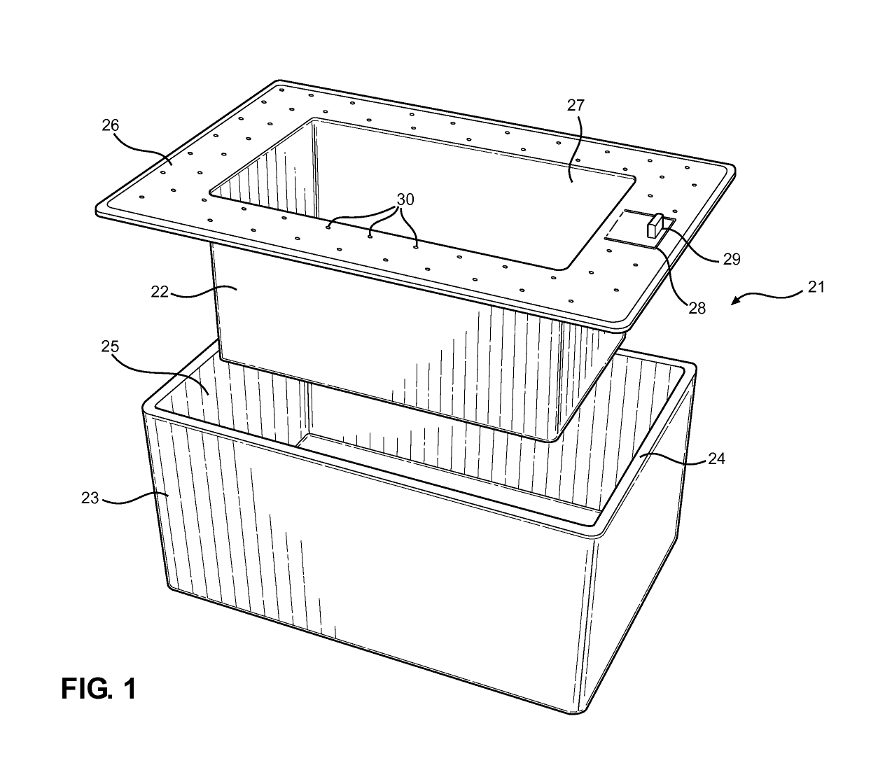

Referring now to FIG. 1, there is shown a disassembled view of the present invention. The insulated baking pan 21 of the present invention comprises an inner pan 22 and an outer pan 23. In the illustrated embodiment, the inner pan 22 and the outer pan 23 comprise a substantially rectangular cross section. The inner pan 22 is dimensioned so that it is adapted to fit within the outer pan 23. The inner pan 22 comprises a closed bottom wall and side walls extending upward therefrom, defining an interior volume 27 and leaving the upper end thereof open. The inner pan 22 is composed of non-stick material such as silicone.

The upper end of the inner pan 22 comprises a flange 26 around the perimeter thereof. The flange 26 extends away from the interior volume 27 of the inner pan 22. Additionally, the flange 26 is substantially perpendicular to the side walls of the inner pan 22. The flange 26 comprises a plurality of apertures 30 thereon. The apertures are separated at regular intervals. One end of the flange 26 comprises an opening with a lid 28 thereon. The lid 28 is hingedly attached to the flange 26 and is structurally integral thereto. The lid 28 comprises a knob 29 thereon, so that the lid 28 can be easily opened and closed.

The outer pan 23 comprises a closed bottom wall and side walls extending upward therefrom, defining an interior volume 25 and leaving the upper end 24 thereof open. The interior volume 25 of the outer pan 23 is dimensioned so that the inner pan 22 can fit therein. Additionally, the outer pan 23 is adapted to hold water therein. It is contemplated that the outer pan 23 is composed of common materials known in the art for baking including, but not limited to, metals such as cast iron, or ceramic material.

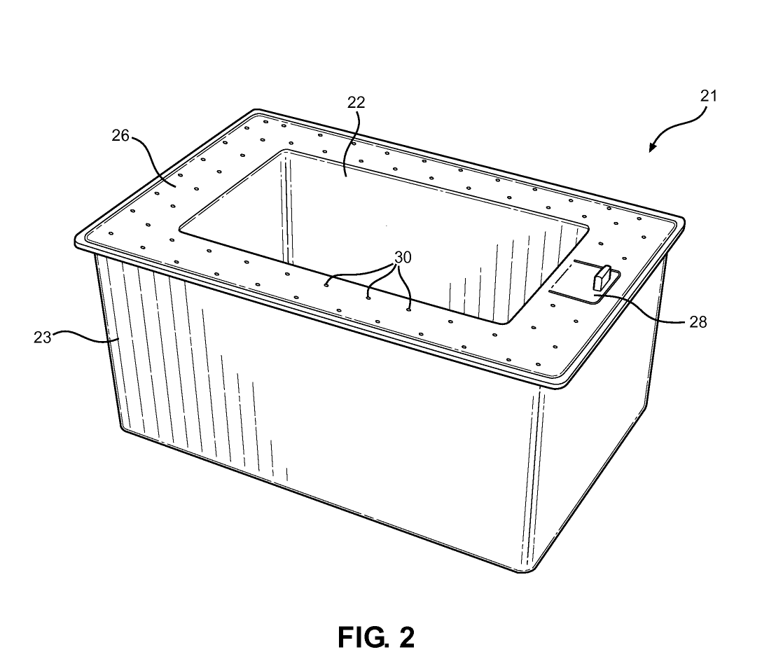

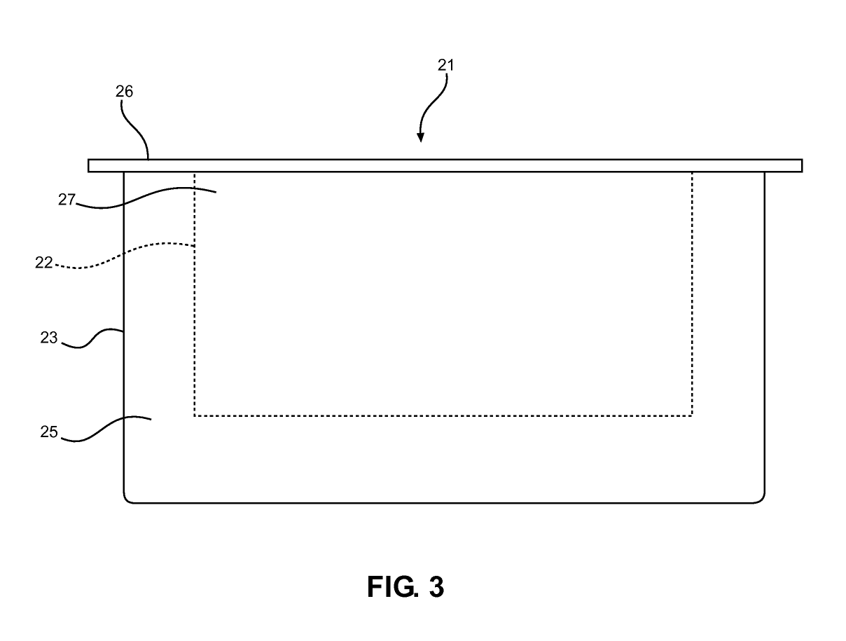

Referring now to FIGS. 2 and 3, there is shown a perspective view of the present invention and a cross sectional view of the present invention, respectively. The inner pan 22 is positioned so that the bottom wall and the side walls of the inner pan 22 extend into the hollow interior 25 of the outer pan 23. The inner pan 22 is dimensioned such that the height and width of each of its bottom wall and its side walls are less than the height and width of each of the bottom wall and the side walls of the outer pan 23. In this way, the side walls and the bottom wall of the inner pan 22 do not contact the side walls and the bottom wall of the outer pan 23, and the inner pan 22 and the outer pan 23 are separated by a space.

In use, the interior volume 25 of the outer pan 23 may be filled with water before the inner pan 22 is placed therein. Thereafter, the inner pan 22 is filled with a batter for a baked good and the insulated baking pan 21 is placed in an oven or a similar appliance. As the insulated baking pan 21 is heated, the water applies heat directly on the bottom wall and the side walls of the inner pan during the baking process. In this way, the water is adapted to distribute heat evenly and slowly so that the food item in the interior volume 27 of the inner pan 22 is baked evenly and thoroughly while preventing the food item from becoming burned.

The flange 26 of the inner pan 22 rests directly on the upper end of the outer pan 23, thereby allowing the bottom wall and the side walls of the inner pan 22 to be suspended within the interior volume 25 of the outer pan 23. Preferably, the flange 26 extends slightly beyond the upper end of the outer pan 23 so that the inner pan 22 can be easily lifted out of the outer pan 23. Additionally, the flange 26 comprises a plurality of apertures 30 thereon, allowing steam or vapor from the hot water to escape from the outer pan 23, and thereby preventing pressure from building up within the interior volume 25 of the outer pan 23. More water can be added through the opening disposed on the flange 26, which is accessible via the lid 28. Accordingly, the inner pan 22 does not need to be removed when more water is added.

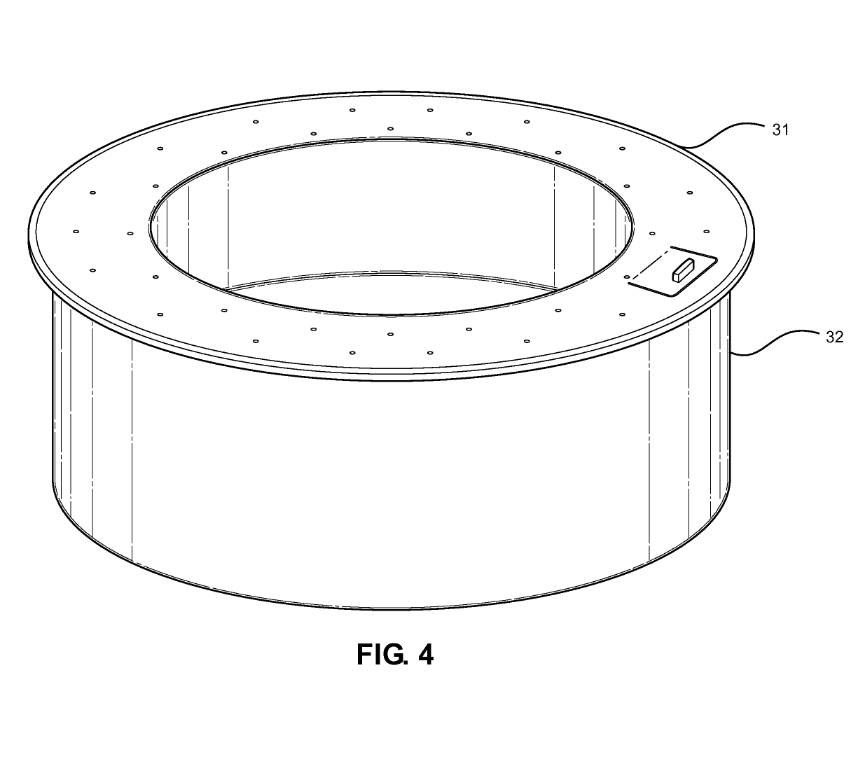

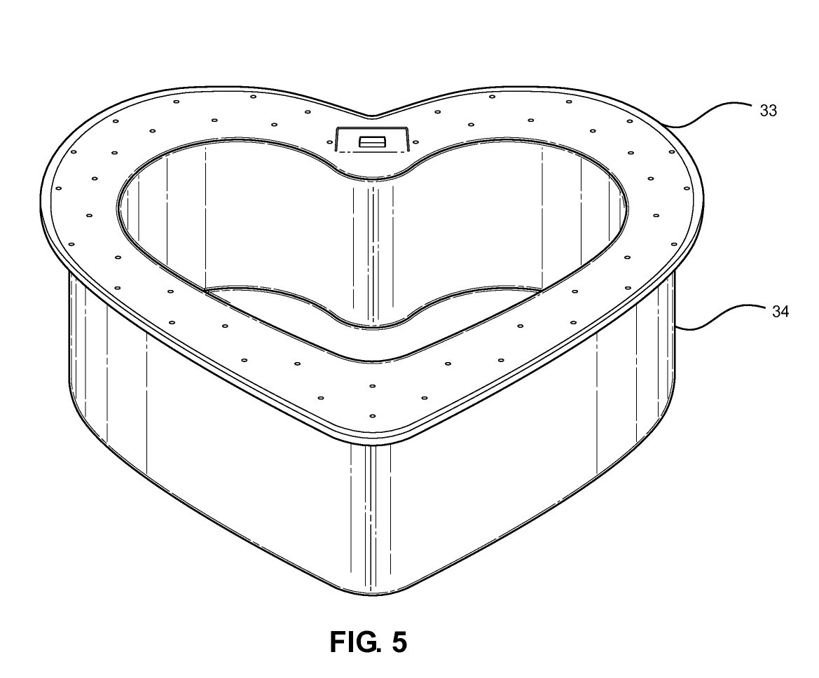

Referring now to FIGS. 4 and 5, there are shown other embodiments of the present invention. The present invention comprises various shapes and designs, depending upon embodiment. For example, the inner pan 31 and the outer pan 32 of the embodiment depicted in FIG. 4 shows a circular shape. The inner pan 33 and the outer pan 34 of the embodiment depicted in FIG. 5 shows a heart shape. As described above, the inner pan of all of the embodiments is composed of insulating material such as silicone. Likewise, the outer pan of all of the embodiments is composed of metal, ceramic material, or other suitable material for baking.

The inner pans 31, 33 are dimensioned so that they fit within the interior volume of the outer pan 32, 34. The bottom wall and the side walls of the inner pans 31, 33 do not contact the bottom wall and the side walls of the outer pans 32, 34 so as to create room for water to be added. The water maximizes contact with the bottom wall and the side walls of the inner pans 31, 33, thereby providing direct heat to the same and allowing the batter contained therein to be baked evenly.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A baking pan, comprising:
an inner pan having a bottom wall and side walls extending upward therefrom, defining an interior volume adapted to hold batter therein;
an outer pan having a bottom wall and side walls extending upward therefrom, defining an interior volume adapted to hold water therein;
said inner pan positionable within said interior volume of said outer pan such that said bottom wall and said side walls of said inner pan and said bottom wall and said side walls of said outer pan are separated by a space;
said inner pan having a flange at an upper end thereof;
said flange of said inner pan adapted to rest on an upper end of said outer pan.

2. The baking pan of claim 1, wherein said flange comprises an opening for providing access to an interior volume of said outer pan when said inner pan is positioned on said outer pan.

3. The baking pan of claim 2, wherein said opening comprises a lid hingedly attached thereto.

4. The baking pan of claim 3, wherein said lid comprises a knob thereon.

5. The baking pan of claim 1, wherein said flange extends beyond said upper end of said outer pan.

6. The baking pan of claim 1, wherein each of said inner pan and said outer pan comprises a rectangular shape.

7. The baking pan of claim 1, wherein each of said inner pan and said outer pan comprises a heart shape.

8. The baking pan of claim 1, wherein each of said inner pan and said outer pan comprises a circular shape.

9. The baking pan of claim 1, wherein said flange comprises a plurality of apertures thereon.

10. The baking pan of claim 1, wherein said flange spans the entire perimeter of said upper end of said inner pan.
